(19) United States
(12) Patent Application Publication
(10) Pub. No.: US 2025/0069801 A1
(43) Pub. Date: Feb. 27, 2025

(54) LEAKAGE TRANSFORMER

(71) Applicant: DIAMOND&ZEBRA ELECTRIC MFG.CO., LTD., Osaka (JP)

(72) Inventors: Yusuke MINE, Osaka (JP); Kazuo OCHIAI, Kanagawa (JP); Shinnosuke TAKENAKA, Osaka (JP); Katsura SHIMADA, Osaka (JP)

(73) Assignee: DIAMOND&ZEBRA ELECTRIC MFG.CO., LTD., Osaka (JP)

(21) Appl. No.: 18/785,511

(22) Filed: Jul. 26, 2024

(30) Foreign Application Priority Data
Aug. 22, 2023 (JP) 2023-134871
Mar. 7, 2024 (JP) 2024-034630

(51) Int. Cl. H01F 38/08; H01F 5/02; H01F 27/00

(52) U.S. Cl. CPC H01F 38/08; H01F 5/02; H01F 27/006

(57) ABSTRACT

The main assembly of a leakage transformer includes a bobbin which includes collar/collars adjacent to location/locations corresponding to a winding edge of a primary coil and/or a secondary coil wound around the bobbin. The collar includes a first collar separating the primary coil and the secondary coil from each other in an axial direction. The leakage transformer includes a bottomed casing within which the main assembly is received and embedded in a filling material. At least one of the collar/collars have a coil facing surface that is formed with a pattern of concavity and convexity. The pattern includes a plurality of protrusions and recesses extending substantially parallel to each other in a longitudinal direction. The recesses of the collar extend in the longitudinal direction and represent channels resembling grooves through which the filling material is passed and guided into the coils present in their vicinity.

### CROSS REFERENCE TO THE RELATED APPLICATION

This application is based on and claims Convention priority to Japanese patent application No. 2023-134871, filed Aug. 22, 2023, and to Japanese patent application No. 2024-034630, filed Mar. 7, 2024, the entire disclosures of all of which are herein incorporated by reference as a part of this application.

### BACKGROUND OF THE INVENTION

### Field of the Invention

The present invention relates to a leakage transformer which includes a bobbin with a primary coil and a secondary coil wound therearound and in which the primary coil and the secondary coil are separated from each other by a collar on the bobbin in order to create a leakage inductance.

### Description of Related Art

Typically, leakage transformers are characterized by a large leakage inductance that is created by separating a primary coil and a secondary coil that are wound around a bobbin fitted to a core, with an insulating collar (or wall) on the bobbin. Their example applications include switched-mode power supplies that exploit the leakage inductance.

A type of leakage transformer is known, for example, which includes an insulating bobbin having, a cylindrical shape, a core inserted through an insertion bore of the bobbin, a primary coil and a secondary coil wound around the outer side of the bobbin, and contacts connected to the coils. The bobbin has a separator (or wall), in addition to collars on both ends of the bobbin, that is provided to physically separate the primary coil and the secondary coil from each other (for example, Patent Document: JP Laid-open Patent Publication No. 2011-124337).

Traditionally, resin-filled transformers are also known which include a bobbin, a core, a primary coil, and a secondary coil that are received and embedded in resin or other filling materials within a casing in order to, among other things, dissipate heat away from the interior of the transformers and prevent insulation failure caused by moisture.

FIG. 9 depicts a vertical cross sectional view of a conventional resin-filled transformer. A primary coil 24 and a secondary coil 25 are wound around a bobbin 22 and physically separated from each other by an insulating wall 26 on the bobbin 22 (namely, in a sector winding configuration). They are embedded in a filling material within a casing 31.

By the way, devices like switched-mode power supplies have been downsized in recent years. This led to a need to use more compact transformers. This can be achieved by winding coils in several layers with little space left in the width of a bobbin, such that the coils are disposed with a high space factor.

Meanwhile, transformers are classified according to heat-resistance grades that are determined by the insulating material (i.e., paint or resin) used with their coils, and need to be held at or below the acceptable temperatures set by the grades. In this connection, increasing the size of transformers will keep the temperature rise small and thereby make it easier for the transformers to be kept at or below their acceptable temperatures.

### SUMMARY OF THE INVENTION

However, in case of transformers that are downsized by winding a primary coil 24 and a secondary coil 25 around a bobbin 22 in several layers with a high space factor as shown in FIG. 9, it is difficult to guide a filling material that has been cast into a casing 31, all the way towards the inner sides of the wound-around coils 24, 25—for example, towards those points, such as a deeper zone A (dashed rectangle in the figure), that are proximate to the outer cylindrical surface of the bobbin (or the upper side portions of the coils in the figure).

This may result in poor heat dissipating performance at the deeper zone A and promote temperature rise that leads to an elevation in temperatures of the interior of the transformer. When this happens, there is a possibility that the leakage transformer may exceed its acceptable temperature. Or, the leakage transformer may not be able to maintain a safe, continuous operation. And it may become difficult to limit the temperature rise to a level that does not cross the acceptable temperature.

An object of the present invention is to provide a resin-filled leakage transformer which can suppress temperature rise inside the transformer in a simple and effective manner despite a compact design of the transformer.

To achieve this object, the present invention provides a leakage transformer which includes a main assembly including a cylindrical bobbin having an insertion bore, a core inserted through the insertion bore of the bobbin, and coil windings wound around the bobbin to form a primary coil and a secondary coil. The bobbin includes more than one collar provided adjacently to more than one location corresponding to a winding edge of the primary coil and/or the secondary coil. The collar includes a first collar separating the primary coil and the secondary coil from each other in an axial direction of the bobbin. Coil spacing is present among the coil windings. The leakage transformer also includes a bottomed casing provided with a volume which has an opening and in which the main assembly is received. The main assembly is embedded in a filling material within the casing. At least one of the more than one collar has a coil facing surface that is formed with a pattern of concavity and convexity. The pattern includes a plurality of protrusions and recesses extending substantially parallel to each other in a longitudinal direction. The recesses of the collar define channels resembling grooves along which the filling material is guided towards the coil spacing in which the filling material is filled and shaped in place.

According to this configuration, the primary coil and the secondary coil are separated from each other in the axial direction by the first collar in order to create a leakage inductance. Also, one or more collars have the coil facing surface that is formed with the pattern of concavity and convexity which includes a plurality of protrusions and recesses extending substantially parallel to each other in a longitudinal direction. The recesses of the collar extend in the longitudinal direction and represent channels resembling grooves through which the filling material is passed and guided into the coils present in their vicinity. Thus, the incorporation of the pattern of concavity and convexity, along which the filling material is guided, into the collar eliminates the need to provide an additional, external guide path and thereby allows corresponding downsizing to be achieved. Hence, temperature rise inside the leakage transformer can be suppressed in a simple and effective manner despite a compact design of the transformer.

Preferably, in the present invention, at least one of the plurality of recesses extending in the longitudinal direction is fixed in such an orientation that an extension thereof in the longitudinal direction passes through a casing opening plane which is defined by the opening of the casing. In this case, the filling material is easily guided from the opening of the casing into the coils present in their vicinity by passing through the recesses of the collar. Hence, temperature rise inside the leakage transformer can be suppressed in an even simpler and effective manner despite a compact design of the transformer.

Also, in the present invention, at least one of the plurality of recesses preferably extends longitudinally in substantial alignment with a vertical direction which is defined perpendicular to the casing opening plane. In this case, the filling material is easily guided downwards from above through the opening of the casing by passing through the recesses of the collar. Hence, temperature rise inside the leakage transformer can be suppressed in an even simpler and effective manner despite a compact design of the transformer.

Further, in the present invention, all of the plurality of recesses preferably extend longitudinally in substantial alignment with a vertical direction which is defined perpendicular to the casing opening plane. In this case, the filling material is more easily guided downwards from above through the opening of the casing by passing through the recesses of the collar. Hence, temperature rise inside the leakage transformer can be suppressed in an even simpler and effective manner despite a compact design of the transformer.

In the present invention, the bobbin may be positioned such that the bobbin extends axially in substantial alignment with a vertical direction which is defined perpendicular to the casing opening plane and at least one of the plurality of recesses extends longitudinally in substantial alignment with a horizontal direction which is defined perpendicular to the vertical direction. In this case, the recesses extending in the longitudinal direction, namely, the horizontal direction, represent channels resembling grooves through which the filling material is passed and guided. Hence, temperature rise inside the leakage transformer can be suppressed in a simple and effective manner despite a compact design of the transformer.

Also, in the present invention, the first collar separating the primary coil and the secondary coil from each other in the axial direction preferably has, on opposite sides thereof, said coil facing surface that is formed with said pattern of concavity and convexity. In this case, the pattern of concavity and convexity, along which the filling material is guided, is incorporated into the first collar separating the primary coil and the secondary coil from each other. Hence, temperature rise of the coils can be suppressed in an even simpler manner despite a compact design.

Preferably, an axial thickness of the first collar or an axial thickness of material delimited by the faces of the protrusions of said pattern of concavity and convexity formed on said coil facing surface on the opposite sides of the first collar creates a prescribed leakage inductance. Hence, temperature rise of the coils can be suppressed in a simple manner despite a compact design, while at the same time creating a prescribed leakage inductance.

Furthermore, the primary coil and the secondary coil are preferably wound in an orthocyclic winding configuration. Thus, a prescribed leakage inductance necessary for a relevant circuitry is secured reliably.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 shows a schematic vertical cross sectional view of a leakage transformer in accordance with an embodiment of the present invention.

FIG. 2 shows a perspective view of a bobbin of the leakage transformer.

FIG. 3 shows a perspective view of a core of the leakage transformer.

FIG. 4 shows a perspective view of the leakage transformer.

FIG. 5 shows a perspective view of a relevant part of the leakage transformer.

FIG. 6 shows a front elevational view of the leakage transformer.

FIG. 7 shows a schematic perspective view of the leakage transformer of FIG. 1.

FIG. 8 shows a schematic vertical cross sectional view of a leakage transformer in accordance with an alternative embodiment.

FIG. 9 shows a schematic vertical cross sectional view of a leakage transformer in accordance with a conventional design.

### DESCRIPTION OF EMBODIMENTS

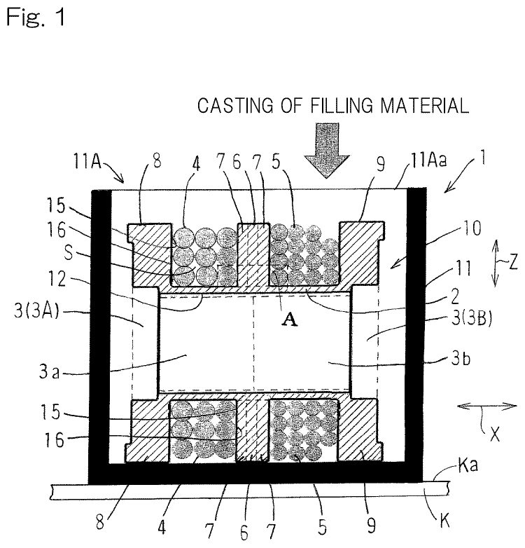

Preferred embodiments of the present invention will be described below with reference to the drawings. FIG. 1 shows a schematic vertical cross sectional view of a leakage transformer 1 in accordance with an embodiment of the present invention. Referring to FIG. 1, the leakage transformer 1 includes a main assembly 10 and a bottomed casing 11. The main assembly 10 includes a cylindrical, insulating bobbin 2 having an insertion bore 12, a core 3 inserted through the insertion bore 12 of the bobbin 2, and coil windings wound around and layered on the outer side of the bobbin 2 to form a primary coil 4 and a secondary coil 5. The casing 11 is provided with a volume which has an opening 11A that is open in an upward direction and within which the main assembly 10 is received. The leakage transformer 1 also includes contacts (not shown) respectively connected to the coils 4, 5. The main assembly 10 is embedded in a filling material within the casing 11. The bottom of the casing 11 is meant to be disposed on a mounting surface Ka of a base K.

Further, the main assembly 10 includes a first collar 6 (or wall) that is formed on the bobbin 2 and arranged between the primary and secondary coils 4, 5 to physically separate them from each other in the axial direction X of the bobbin 2, and also includes second and third collars 8, 9 that are formed on both ends of the bobbin 2. These collars 6, 8, 9 are provided adjacently to several locations corresponding to the winding edges 15 (or the opposite edges in the axial direction X) of the primary coil 4 and/or the secondary coil 5 wound around and layered on the bobbin 2. For instance, the primary coil 4 and the secondary coil 5 are wound in an orthocyclic winding (and sector winding) configuration.

The main assembly 10 is embedded in the filling material within the casing 11 to achieve benefits like dissipation of heat away from the interior of the transformer and prevention of insulation failure caused by moisture. Examples of the filling material used include a gel-like silicone resin and an epoxy resin. Examples of material from which the casing 11 is made include a polycarbonate (PC), a polyethylene terephthalate (PET), and metal material.

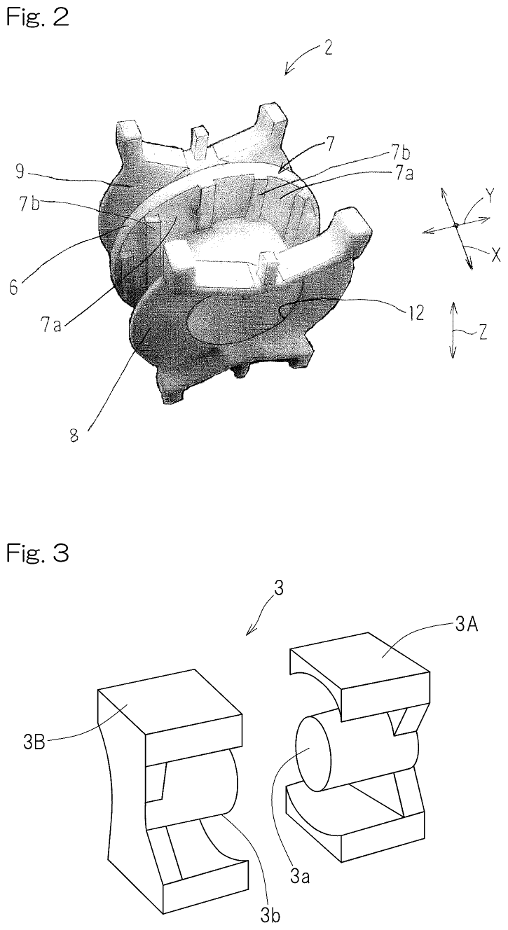

FIGS. 2 to 6 show diagrams of individual parts of the leakage transformer 1 before it is received in the casing. FIG. 2 shows a perspective view of the bobbin 2. The bobbin 2 has a cylindrical shape with the collars 8, 9 formed on both ends in the axial direction X and the first collar 6 formed to separate the coils 4, 5 from each other. In FIG. 1, the axial direction X of the bobbin 2, as well as a casing opening plane 11Aa of the opening 11A of the casing which will be further discussed later, substantially coincide with a horizontal direction. Examples of material from which the bobbin 2 and the collars 6, 8, 9 are made include a polyethylene terephthalate (PET), a phenolic resin (PF), and other such insulating resins.

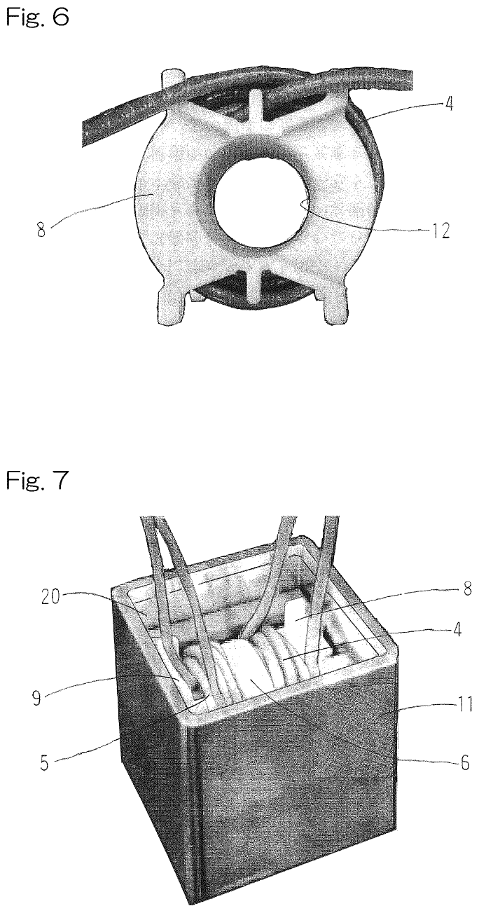

Central legs 3a, 3b of the core such as, for example, a PQ core 3 (3A, 3B) of FIG. 3 are inserted through the insertion bore 12 of the bobbin 2 (FIG. 1) such as the one in FIG. 6. Instead of the PQ core, an EE core, an EER core, and any other cores that have central legs can also be used as the core 3. In the instant example, no gap is provided between the central legs 3a, 3b as in FIG. 1.

In the instant example, the first collar 6 (or wall) separating the primary coil 4 and the secondary coil 5 from each other has, on opposite sides thereof, a coil facing surface 16 (or a lateral surface that comes into abutment with a winding edge 15) which is formed with a pattern 7 of concavity and convexity as in FIG. 1, such that a plurality of protrusions 7b and recesses 7a are adjacently arranged in a widthwise direction Y (or a circumferential direction of the collars) that lies perpendicular to the axial direction X and are formed to extend substantially parallel to each other in the longitudinal direction Z (or a vertical direction) as in FIG. 2.

As in FIG. 1, the recesses 7a of the first collar 6 extend in the longitudinal direction Z (or the vertical direction), are defined between the protrusions 7b, and represent channels resembling grooves through which the filling material is passed and guided into the coils 4, 5 present in their vicinity and towards coil spacing S, which is spacing present between the wires of the wound-around and layered coils and in which the filling material is filled and shaped in place. The filling material is filled in during a production process and cured and set in place during a curation process.

As in FIG. 1, the recesses and protrusions 7 extend in the longitudinal direction Z (or the vertical direction) which is a direction in which the coils 4, 5 are layered. Hence, the filling material that has been cast from the opening 11A passes through the recesses 7a resembling grooves, among the recesses and protrusions 7 formed on the opposite sides of the first collar 6, and is guided towards those locations which were conventionally hard for the filling material to reach, such as, for example, a deeper zone A that is proximate to the outer cylindrical surface of the bobbin (or the upper side portions of the coils in the figure). In addition, the recesses 7a resembling grooves, among the recesses and protrusions 7, easily let the filling material pass therethrough and guide the same towards portions in the lower side of the coils that are likewise proximate to the outer cylindrical surface of the bobbin. By letting the filling material pass through the recesses 7a, which are formed in the first collar 6 and resemble grooves, to guide the same into the coils 4, 5 present in their vicinity in this way, the need to provide an additional, external guide path for the same purpose is eliminated. By forming in the first collar 6 the recesses and protrusions 7 with which to guide the filling material, it is possible to downsize the leakage transformer 1.

The plurality of recesses 7a extending in the longitudinal direction Z (or the vertical direction) are fixed in such an orientation that the extensions thereof in the longitudinal direction Z pass through the casing opening plane 11Aa which is defined by the opening 11A of the casing. In this case, the filling material is easily guided from the opening 11A of the casing into the coils 4, 5 present in their vicinity by passing through the recesses 7a of the first collar 6. While the extensions of all of the plurality of recesses 7a pass through the opening plane 11Aa in the instant example, the extension of at least one of the recesses 7a may alternatively pass through the opening plane 11Aa.

Further, the plurality of recesses 7a extend longitudinally in substantial alignment with the vertical direction Z which lies perpendicular to a mounting surface of a base when the bottom of the casing is disposed on the mounting surface. In this case, the filling material is easily guided downwards from above through the opening 11A of the casing by passing through the recesses 7a of the collar 6. While all of the plurality of recesses 7a extend longitudinally in substantial alignment with the vertical direction Z in the instant example, at least one of the recesses 7a may alternatively extend longitudinally in substantial alignment with the vertical direction Z. In addition to perfect alignment in direction, the term “substantial alignment” preferably encompasses possible deviations in direction of up to +10 degrees, more preferably up to +5 degrees. It even permits deviations in direction which exceed these numerical ranges in cases where the recesses 7a with such a deviation are shown to promote removal of air bubbles, facilitate the impregnation of the filling material, or produce other such advantages, for example.

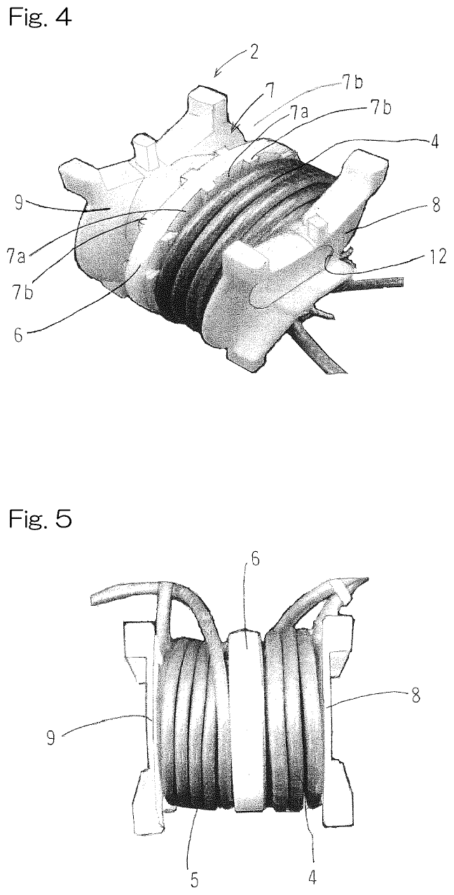

The axial thickness delimited by the faces, of opposite lateral sides (mentioned below), of and between the protrusions 7b (FIG. 4) of the pattern 7 of concavity and convexity formed on the opposite lateral sides of the first collar 6 (or wall) creates a prescribed leakage inductance. For instance, the primary coil 4 and the secondary coil 5 are wound in an orthocyclic winding configuration. Thus, a prescribed leakage inductance necessary for a circuitry is secured reliably. Moreover, a gap may be provided between the central legs 3a, 3b if necessary, even though the variance of this gap has little influence on the leakage inductance which is governed by the axial thickness of the first collar 6.

As in FIG. 4, the primary coil 4 is wound with little space left in the area between the second collar 8 and the first collar 6 which is formed with the recesses and protrusions 7. As in FIG. 5, the secondary coil 5 is wound with little space left in the area between the first collar 6 and the third collar 9. Hence, the coils 4, 5 are both wound around the bobbin 2 in a space-free manner. As in FIG. 6, the primary coil 4 is wound in several layers. Although invisible in the figure, the secondary coil 5 is similarly wound in several layers.

Thus, the primary coil 4 and the secondary coil 5 are disposed with a high space factor within the bobbin 2 by being wound in several layers with little space left between the second collar 8 and the first collar 6 (or wall) and between the third collar 9 and the first collar 6 of the bobbin 2, respectively.

FIG. 7 depicts the main assembly 10 that has been assembled as described above, received within the casing 11, and embedded in the filling material 20. Here, as in FIGS. 1 and 2, the filling material 20 passes through the recesses 7a of the pattern 7 of concavity and convexity formed in the first collar 6 and is guided towards those points in the coils 4, 5 present in their vicinity which were conventionally hard for the filling material 20 to reach. Accordingly, temperature rise inside the transformer can be suppressed in an effective manner.

Thus, in a leakage transformer 1 according to the present invention, the primary coil 4 and the secondary coil 5 are separated from each other in the axial direction X by the first collar 6 in order to create a leakage inductance. Also, the first collar 6 has, on opposite sides thereof, a coil facing surface 16 that is formed with the pattern 7 of concavity and convexity which includes a plurality of protrusions 7b and recesses 7a extending substantially parallel to each other in the longitudinal direction Z. The recesses 7a of the pattern 7 of concavity and convexity resemble grooves through which the filling material 20 is passed and guided in the longitudinal direction Z (or the vertical direction) into the coils 4, 5 present in their vicinity. Thus, the incorporation of the pattern 7 of concavity and convexity, along which the filling material 20 is guided, into the first collar 6 eliminates the need to provide an additional, external guide path for the same purpose and thereby allows corresponding downsizing to be achieved. Hence, temperature rise inside the leakage transformer can be suppressed in a simple and effective manner despite a compact design of the transformer.

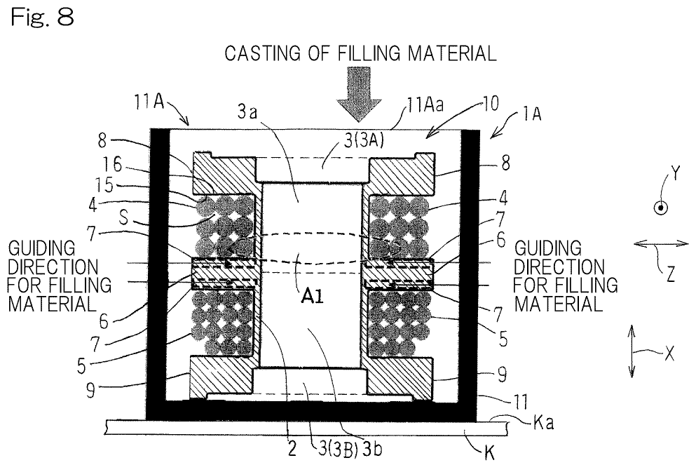

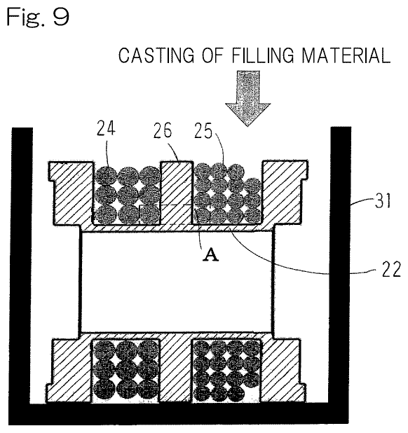

FIG. 8 shows a schematic vertical cross sectional view of a leakage transformer 1A in accordance with an alternative embodiment. In the leakage transformer 1A, a main assembly 10 is tilted by 90 degrees with respect to FIG. 1 and received into a casing 11, such that protrusions 7b and recesses 7a of a pattern 7 of concavity and convexity are adjacently arranged in a depthwise direction Y that lies perpendicular to the axial direction X of a bobbin 2 (or the vertical direction) and are formed to extend substantially parallel to each other in the longitudinal direction Z (or the widthwise direction). In other words, the leakage transformer 1A in the alternative embodiment differs from that of FIG. 1 in which the bobbin 2 extends axially in substantial alignment with the horizontal direction, in that the bobbin 2 extends axially in substantial alignment with the vertical direction X and the plurality of recesses 7a extend longitudinally in substantial alignment with the horizontal direction Z which is defined perpendicular to the vertical direction X. The bottom of the casing 11 is likewise meant to be disposed on a mounting surface Ka of a base K. The rest of the features are similar to those of FIG. 1.

In this case, the recesses 7a extend in the widthwise direction or the longitudinal direction Z of the pattern 7 of concavity and convexity and represent channels resembling grooves through which the filling material 20 that has been cast from the opening 11A is passed in the longitudinal direction Z (or the widthwise direction) and guided towards those points (A1) of the coils 4, 5 present in their vicinity that are near the outer cylindrical surface of a coil. Hence, temperature rise inside the leakage transformer can be likewise suppressed in a simple and effective manner despite a compact design of the transformer.

It should be noted that the pattern of concavity and convexity on a coil facing surface may alternatively be provided on only one of the opposite sides of the first collar 6 (or wall), instead of both of the opposite sides of the first collar 6 (or wall) in each of the embodiments. Further, in addition to or as an alternative to the pattern of concavity and convexity on the first collar 6, the pattern of concavity and convexity may be provided on a coil facing surface of the second and/or third collars 8, 9.

Moreover, while the main assembly is received in the casing in the instant embodiment, the casing may be omitted if the resinous filling material can hold a stable shape after the filling is done.

It should be noted that while the primary coil and the secondary coil are wound in an orthocyclic winding configuration in the instant embodiment, they may alternatively be wound in a bank winding configuration. In this case, the coils can be wound with an even higher space factor, thus, allowing for further downsizing.

What has been described are only a few of the non-limiting embodiments of the present invention. Various additions, changes, or omissions can be made therein without departing from the principle of the present invention and are therefore construed to be encompassed within the scope of the present invention.

### REFERENCE SYMBOLS

1 . . . leakage transformer
2 . . . bobbin
3 . . . core
4 . . . primary coil
5 . . . secondary coil
6 . . . first collar (wall)
7 . . . pattern of concavity and convexity
7a . . . recess
7b . . . protrusion
8 . . . second collar
9 . . . third collar
10 . . . main assembly
11 . . . casing
11A . . . opening of casing
11Aa . . . casing opening plane
12 . . . insertion bore
15 . . . winding edge
16 . . . coil facing surface
20 . . . filling material
K . . . base
Ka . . . mounting surface
S . . . coil spacing
X . . . axial direction of bobbin
Y . . . direction perpendicular to axial direction of bobbin
Z . . . longitudinal direction of pattern of concavity and convexity

What is claimed is:

1. A leakage transformer comprising:
a main assembly including
a bobbin with a cylindrical shape having an insertion bore,
a core inserted through the insertion bore of the bobbin, and
coil windings wound around the bobbin to form a primary coil and a secondary coil, the bobbin including more than one collar provided adjacently to more than one location corresponding to a winding edge of the primary coil and/or the secondary coil, the collar including a first collar separating the primary coil and the secondary coil from each other in an axial direction of the bobbin, and coil spacing being present among the coil windings; and
a casing having a bottom provided with a volume which has an opening and in which the main assembly is received, the main assembly being embedded in a filling material within the casing, at least one of the more than one collar having a coil facing surface that is formed with a pattern of concavity and convexity, the pattern including a plurality of protrusions and recesses extending substantially parallel to each other in a longitudinal direction, the recesses of the collar defining channels resembling grooves along which the filling material is guided towards the coil spacing in which the filling material is filled and shaped in place.

2. The leakage transformer as claimed in claim 1, wherein at least one of the plurality of recesses extending in the longitudinal direction is fixed in such an orientation that an extension thereof in the longitudinal direction passes through a casing opening plane which is defined by the opening of the casing.

3. The leakage transformer as claimed in claim 2, wherein at least one of the plurality of recesses extends longitudinally in substantial alignment with a vertical direction which is defined perpendicular to the casing opening plane.

4. The leakage transformer as claimed in claim 2, wherein all of the plurality of recesses extend longitudinally in substantial alignment with a vertical direction which is defined perpendicular to the casing opening plane.

5. The leakage transformer as claimed in claim 1, wherein the bobbin is positioned such that the bobbin extends axially in substantial alignment with a vertical direction which is defined perpendicular to the casing opening plane and at least one of the plurality of recesses extends longitudinally in substantial alignment with a horizontal direction which is defined perpendicular to the vertical direction.

6. The leakage transformer as claimed in claim 1, wherein the first collar separating the primary coil and the secondary coil from each other in the axial direction has, on opposite sides thereof, said coil facing surface that is formed with said pattern of concavity and convexity.

7. The leakage transformer as claimed in claim 1, wherein an axial thickness of the first collar or an axial thickness of material delimited by faces of the protrusions of said pattern of concavity and convexity formed on said coil facing surface on the opposite sides of the first collar creates a prescribed leakage inductance.

8. The leakage transformer as claimed in claim 7, wherein the primary coil and the secondary coil are wound in an orthocyclic winding configuration.
